(19) United States
(12) Patent Application Publication
(10) Pub. No.: US 2012/0317337 A1
(43) Pub. Date: Dec. 13, 2012

(54) MANAGING DATA PLACEMENT ON FLASH-BASED STORAGE BY USE

(75) Inventors: Akshay Johar, Bellevue, WA (US); Jered Aasheim, Bellevue, WA (US)

(73) Assignee: MICROSOFT CORPORATION, Redmond, WA (US)

(21) Appl. No.: 13/156,361

(22) Filed: Jun. 9, 2011

(51) Int. Cl. G06F 12/00

(52) U.S. Cl. 711/103; 711/E12.008

(57) ABSTRACT

A storage placement system is described herein that uses an operating system's knowledge related to how data is being used on a computing device to more effectively communicate with and manage flash-based storage devices. Cold data that is not frequently used can be differentiated from hot data clusters and placed in worn areas, while hot data that is frequently used can be kept readily accessible. By clustering hot data together and cold data in separate sections, the system is better able to perform wear leveling and prolong the usefulness of the flash medium. Storage of data in the cloud or other storage can intelligently persist data in a location for a short time before coalescing data to write in a block. Thus, the system leverages the operating system's knowledge of how data has been and will be used to place data on flash-based storage devices in an efficient way.

### BACKGROUND

Data storage hardware has changed in recent years so that flash-based storage is much more common. Rotational media such as hard drives and optical disc drives are increasingly being replaced by flash-based storage, such as solid-state disk (SSD) drives, which have no moving parts. Solid-state disks are much more robust and are more impervious to many types of environmental conditions that are harmful to previous media. For example, rotating media is particular prone to shocks that can occur, for example, when a mobile computing device containing one is dropped. Flash-based storage also typically has much faster access times and each area of the storage can be accessed with uniform latency. Rotational media exhibits differing speed characteristics based on how close to the central spindle (where the disk rotates faster) data is stored. SSDs, on the other hand, have a fixed amount of time to access a given memory location, and do not have a traditional seek time (which referred to the time to move the reading head for rotational media).

Unfortunately, SSDs do introduce new limitations as far as how they are read, written, and particularly erased. Typical flash-based storage can only be erased a block at a time, although non-overlapping bits within a block can be set at any time. In a typical computing system, an operating system writes a first set of data to an SSD page, and if a user or the system modifies the data, the operating system either rewrites the entire page or some of the data to a new location, or erases the whole block and rewrites the entire contents of the page. SSD lifetimes are determined by an average number of times that a block can be erased before that area of the drive is no longer able to maintain data integrity (or at least cannot be effectively erased and rewritten). The repeated erasing and rewriting of blocks and pages, respectively, by operating systems only hastens an SSD's expiration.

Several techniques have been introduced to help SSDs last longer. For example, many drives now internally perform wear leveling, in which the firmware of the drive selects a location to store data in a manner that keeps each block erased about the same number of times. This means that the drive will not fail due to one area of the drive being overused while other areas are unused (which could result in the drive appearing to get smaller over time or failing entirely). In addition, the TRIM command was introduced to the Advanced Technology Attachment (ATA) standard to allow an operating system to inform an SSD which blocks of data are no longer in use so that the SSD can decide when to erase. Ironically, disk drives of all types do not know which blocks are in use. This is because operating systems write data and then often only mark a flag to indicate it is deleted at the file system level. Because the drive does not typically understand the file system, the drive cannot differentiate a block in use by the file system from a block no longer in use because the data has been marked as deleted by the file system. The TRIM command provides this information to the drive.

While these techniques are helpful, they still rely on the drive to mostly manage itself, and do not provide sufficient communication between the drive and the operating system to allow intelligent decision making outside of the drive to prolong drive life.

### SUMMARY

A storage placement system is described herein that uses an operating system's knowledge related to how data is being used on a computing device to more effectively communicate with and manage flash-based storage devices. Wear leveling is an issue in SSDs that brings focus to hot and cold data identification and placement techniques to play an important role in prolonging the flash memory used by SSDs and improving performance. Cold data that is not frequently used can be differentiated from hot data clusters and subsequently placed in worn areas of the flash medium, while hot data that is frequently used can be kept readily accessible. By clustering hot data together and cold data in separate sections, the system is better able to perform wear leveling and prolong the usefulness of the flash medium. Storage of data in the cloud or other storage may also be used for intelligently persisting data in a location for a short time before coalescing data to write in a block. Hot data can also be stored closer while cold data may be stored farther away. Thus, the storage placement system leverages the operating system's knowledge of how data has been and will be used to place data on flash-based storage devices in an efficient way.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the storage placement system, in one embodiment.

FIG. 2 is a flow diagram that illustrates processing of the storage placement system to write data to a selected location on a flash-based storage device, in one embodiment.

FIG. 3 is a flow diagram that illustrates processing of the storage placement system to select a placement location for data to be written on a flash-based storage device, in one embodiment.

FIG. 4 is a flow diagram that illustrates processing of the storage placement system to handle potential drive or location expiration of a flash-based storage drive, in one embodiment.

### DETAILED DESCRIPTION

A storage placement system is described herein that uses an operating system's knowledge related to how data is being used on a computing device to more effectively communicate with and manage flash-based storage devices. Wear leveling is an issue in SSDs that brings focus to hot and cold data identification and placement techniques to play an important role in prolonging the flash memory used by SSDs and improving performance. Cold data that is not frequently used can be differentiated from hot data clusters and subsequently placed in worn areas of the flash medium, while hot data that is frequently used can be kept readily accessible. By clustering hot data together and cold data in separate sections, the system is better able to perform wear leveling and prolong the usefulness of the flash medium.

Wear leveling in solid-state drives (SSD) is used to recycle memory and prolong the life of the flash-based storage device. Without wear leveling, highly written locations would wear out quickly, while other locations may end up rarely being used. By analyzing the locality of reference, hot and cold data can be identified and strategically placed in memory to minimize wear. One approach is to use block clustering which utilizes a bitmap to determine used and free memory. The system may also keep a count of the number of times a block has been erased. As the erasure count approaches the safe threshold, colder and colder data can be migrated to these blocks. Clusters that are used are marked and if the cluster is recyclable, the cluster can be marked with one value, and marked with another value if it is non-usable. Cold data can then be parked in the “warm” areas. Additionally, the system provides techniques for moving data around intelligently. Clustering hot data together helps make garbage collection easier and helps the system identify clusters of memory for reuse. Storage of data in the cloud or other storage may also be used for intelligently persisting data in a location for a short time before coalescing data to write in a block. Hot data can also be stored at shorter latency accessible locations while cold data is stored at longer latency accessible locations (e.g., cold data that is not accessed frequently may be stored in data centers farther away). Thus, the storage placement system leverages the operating system's knowledge of how data has been and will be used to place data on flash-based storage devices in an efficient way.

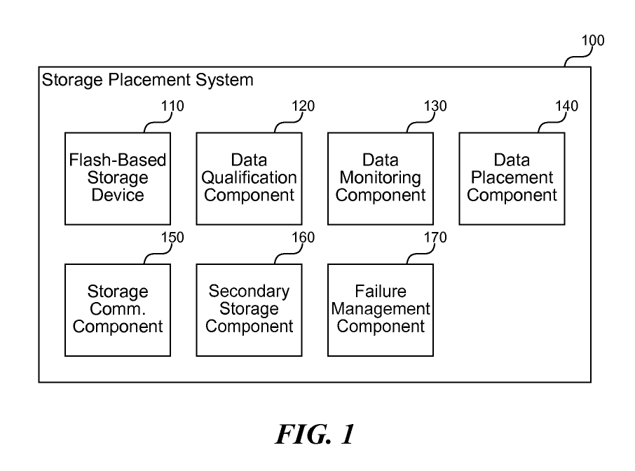

FIG. 1 is a block diagram that illustrates components of the storage placement system, in one embodiment. The system 100 includes a flash-based storage device 110, a data qualification component 120, a data monitoring component 130, a data placement component 140, a storage communication component 150, a secondary storage component 160, and a failure management component 170. Each of these components is described in further detail herein.

The flash-based storage device 110 is a storage device that includes at least some flash-based non-volatile memory. Flash-based memory devices can include SSDs, universal serial bus (USB) drives, storage built onto a motherboard, storage built into mobile smartphones, and other forms of storage. Flash-based storage devices typically include NAND or NOR flash, but can include other forms of non-volatile random access memory (RAM). Flash-based storage devices are characterized by fast access times, blocked-based erasing, and finite quantity of non-overlapping writes that can be performed per page. A flash drive that can no longer be written to is said to have expired or failed.

The data qualification component 120 qualifies data received by an operating system to characterize the degree to which the data is likely to be written, wherein data that is written frequently is called hot data and data that is written infrequently is called cold data. Data may also be qualified by how it is read, as it is sometimes desirable to place data that is read frequently in a different location than data that is read infrequently. Data that is read very infrequently may even be a good candidate for moving to other external storage facilities, such as an optical disk or a cloud-based storage service, to free up room on the computing device's local drive. The data qualification component 120 may access historical data access information acquired by the data monitoring component 130, as well as using specific-knowledge implicitly or explicitly supplied by the operating system about particular data's purpose. For example, in the File Allocation Table (FAT) file system, the file allocation table itself is written very frequently (i.e., every time other data is touched), and thus the operating system knows that any FAT-formatted drive has an area of storage that contains very frequently updated data. For other files/locations, the data qualification component 120 may use file modification times, file types, file metadata, other data purpose information, and so forth to determine whether data is likely to be hot written or cold written data (or hot read or cold read), and to inform the data placement component 140 accordingly.

The data monitoring component 130 monitors data read and written by an operating system and stores historical use information for data. The data monitoring component 130 may monitor which files are used under various conditions and at various times, which files are often accessed together, how important or recoverable a particular data file is, and so forth. The data monitoring component 130 provides historical usage information to the data qualification component 120, so that the data qualification component 120 can qualify data as hot or cold based on its write and/or read characteristics. The data monitoring component 130 and other components of the system 100 may operate within the operating system, such as in the file system layer as a driver or file system filter.

The data placement component 140 determines one or more locations to which data to be written to the flash-based storage device 110 will be written among all of the locations available from the device 110. The data placement component 140 uses the qualification of data determined by the data qualification component 120 to determine where data will be located. The data placement component 140 may also use the storage communication component 150 to access drive information, such as wear leveling or counts tracked by the drive firmware. The data placement component 140 then selects a location that is good for both the longevity of the drive and a level of performance appropriate for the data to be written. For example, if the data is qualified as cold data and the drive includes several very worn blocks, then the component 140 may elect to place the cold data in the worn blocks, so that other less worn blocks can be reserved for data that needs to be written more frequently. In some cases, when a block of the drive is nearing end of life (i.e., cannot handle further writes), the operating system may be able to identify constant read-only data which can be written to the location for one last time and not moved again (e.g., infrequently updated operating system files). For warmer data, the component 140 may select a less worn area of the drive or even a secondary storage location in which the data can reside while it is changing frequently, to be written to the flash-based storage device 110 when the data is more static.

The storage communication component 150 provides an interface between the other components of the system 100 and the flash-based storage device 110. The storage communication component 150 may leverage one or more operating system application-programming interfaces (APIs) for accessing storage devices, and may use one or more protocols, such as Serial ATA (SATA), Parallel ATA (PATA), USB, or others. The component 150 may also understand one or more proprietary or specific protocols supported by one or more devices or firmware that allows the system 100 to retrieve additional information describing the available storage locations and layout of the flash-based storage device 110.

The secondary storage component 160 provides storage external to the flash-based storage device 110. The secondary storage may include another flash-based storage device, a hard drive, an optical disk drive, a cloud-based storage service, or other facility for storing data. In some cases, the secondary storage may have different and even complementary limitations to the flash-based storage device 110, such that the secondary storage is a good choice for some data that is less efficiently stored or unnecessarily wearing for the flash-based storage device 110. For example, an operating system may elect to store a file allocation table or other frequently changing data on a secondary storage device instead of writing frequently to the flash-based storage device. As another example, the operating system may elect to store infrequently used cold data using a cloud-based storage service where the data can be accessed if it is ever requested at a slower, but acceptable rate.

The failure management component 170 handles access and/or movement of data to and from the flash-based storage device 110 as the device is approaching its wear limit. The component 170 may assist the user in moving data to less worn areas of the device 110 or in getting data off the device 110 to avoid data loss. For example, if a file has not been accessed for seven years, the component 170 may suggest that the user allow the system 100 to delete that file from a less worn location to allow other, more significant data to be written to that location. Similarly, the component 170 may assist the user to locate easily replaced files (e.g., operating system files that could be reinstalled from an optical disk) that can be deleted or moved to allow room for more difficult to replace data files that are in over-worn areas of the device 110.

The computing device on which the storage placement system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

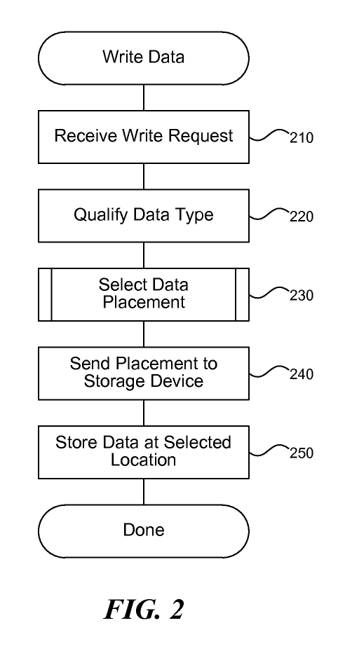

FIG. 2 is a flow diagram that illustrates processing of the storage placement system to write data to a selected location on a flash-based storage device, in one embodiment.

Beginning in block 210, the system receives a request to write data to a flash-based storage device. The request may originate from a user request received by a software application, then be received by an operating system in which the storage placement system is implemented as a file system driver or other component to manage placement of data on flash-based devices. The received request may include some information about the data, such as a location within a file system where the data will be stored, and may give some information as to the purpose, frequency of access, and the type of access (read/write), needed for the data. For example, if the data is being written to a location within a file system reserved for temporary files, then the system may predict that the data will be written frequently for a short time and then deleted. Similarly, if a file is opened with a “delete on close” flag set, the operating system may conclude the file will be used briefly and then deleted.

Continuing in block 220, the system qualifies a frequency of access associated with the data to be written to the flash-based storage device. If the data is written frequently, it is considered hot write data, if it is read frequently it is considered hot read data, if it is written infrequently it is considered cold write data, and if it is written read infrequently it is considered cold read data. The system will prefer to write hot data to a location where frequent writes will not cause problems such as expiration of a flash block, and to write cold data where that data can suitably reside (potentially a well-worn block that would be unsuitable for other data). The system may qualify the data based on historical access patterns for a file system location associated with the data, based on information received with the request, based on well-known operating system implementation information, and so forth.

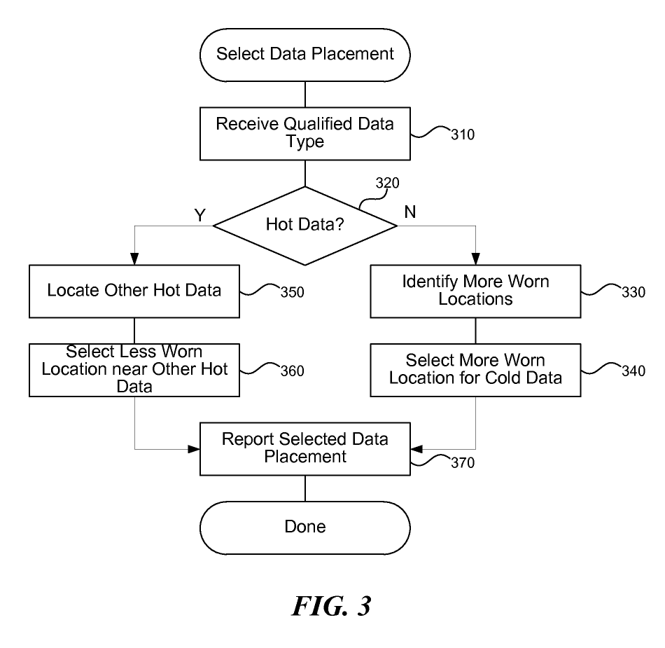

Continuing in block 230, the system selects a data placement location on the flash-based storage device for the data to be written. The location may be provided as a memory address or other identification of a location within the device's address space. In some cases, the system may inform the drive whether the data is hot, cold, or somewhere in between, and allow the drive to select a location for the data. Regardless, the system provides at least some hint relevant to selecting data placement to the drive. The data placement component may identify a worn block as a suitable location for data that will not be written again for a long time, if ever, and may select a fairly unused block for data to be written frequently. Alternatively or additionally, the system may select a location on a separate, secondary storage device for holding data that is less suitable for the flash-based storage device. The system may opt to store hot data elsewhere that would unnecessarily wear the device and cold data elsewhere that would unnecessarily fill the device. This step is described further with reference to FIG. 3 herein.

Continuing in block 240, the system sends placement information to the flash-based storage device, indicating the selected data placement location for the data to be written. The system may provide the information to the device as a parameter to a command for writing data to the drive, or as a separate command before data is written to inform the drive of a suggested location for upcoming data.

Continuing in block 250, the system stores the requested data at the selected data placement location on the flash-based storage device. In addition, the system would also store the metadata about this data either on the flash-based storage device or on a secondary storage device. Over time, the system may elect to move the data or to write other data near the data. For example, the system may write other data frequently used with the previously written data to a neighboring location, or may move hot data to a less worn location over time as the initial chosen location becomes worn by frequent use. After block 250, these steps conclude.

FIG. 3 is a flow diagram that illustrates processing of the storage placement system to select a placement location for data to be written on a flash-based storage device, in one embodiment.

Beginning in block 310, the system receives information that qualifies an access frequency of data to be written to the flash-based storage device. For example, the information may indicate whether the data will be written frequently or infrequently. The information may also indicate a purpose for the data (e.g., temporary file, user data storage, executable program, and so forth) from which the system can derive or guess the data's access frequency.

Continuing in decision block 320, if the system determines that the data will be written frequently, then the system continues at block 350, else the system continues at block 330. Frequently written data is referred to as hot data and will be placed in a less worn location of the device, while infrequently written data is referred to as cold data and may be placed in a more worn location of the device.

Continuing in block 330, upon determining that the data will be infrequently written, the system identifies one or more worn locations of the flash-based storage device at which the infrequently written data can reside to leave less worn locations available for other data. The drive and/or operating system data may include information about how many times each location of the flash-based storage device has been erased, so that the system can select a location that is near expiration or otherwise is less suitable for other types of data but sufficiently suitable for infrequently written data.

Continuing in block 340, the system selects one of the identified more worn locations to which to write the data. The system may select by sorting the data and selecting the most worn location or by any other heuristic or algorithm that provides an acceptable selection of location to which to write the data. In some embodiments, the system may provide a configuration interface through which an administrator can alter the behavior of the system during location selection to select based on some criteria preferred by the administrator. After block 340, execution jumps to block 370.

Continuing in block 350, upon determining that the data will be frequently written, the system locates any other frequently written data related to the data to be written. The system may attempt to place frequently written data together, to produce efficiencies in updating the data, to allow whole blocks to be erased together, and so forth. The system may attempt to avoid fragmenting data in a manner such that frequently and infrequently written data is located near each other or on the same flash-based block. Doing so allows the system to be more certain that when one chunk of data is ready to be erased, other neighboring data will also be ready for erasure or will soon be ready for erasure so that the system can recover more drive space.

Continuing in block 360, the system selects a less worn location near the other frequently written data at which to place the data to be written. The drive and/or operating system data may include information about how many times each location of the flash-based storage device has been written, so that the system can select a location that is fresh or has not been written excessively and is suitable for frequently written data. The system may sort the wear characteristics of locations and select the least worn location or may prefer to weight those locations that are near to other frequently written data more heavily to select one of those locations to a less worn location. In some embodiments, an administrator can modify configuration settings to instruct the system how to make the selection.

Continuing in block 370, the system reports the selected placement so that other components can write the data there. For example, the system may output the results of selecting data placement as an input to further steps as those outlined in FIG. 2. In some embodiments, the system may be used as part of a tool that performs analysis of data placement and reports back to the user before taking any action. In such cases, the output may be provided to the user in a file or user interface so that the user can evaluate how data is placed on the device. After block 370, these steps conclude.

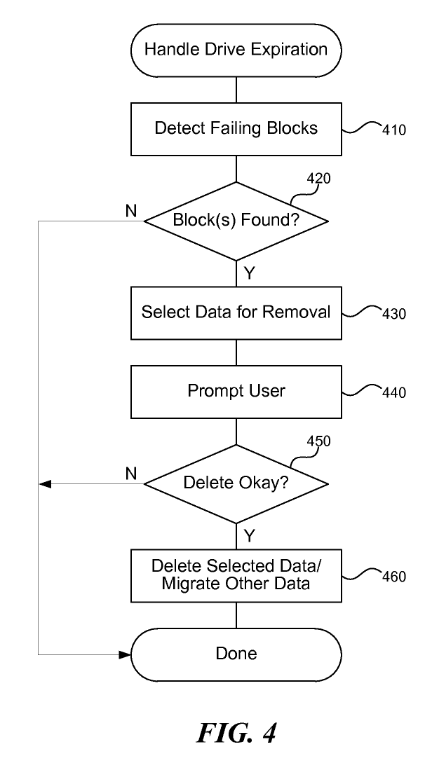

FIG. 4 is a flow diagram that illustrates processing of the storage placement system to handle potential drive or location expiration of a flash-based storage drive, in one embodiment.

Beginning in block 410, the system detects one or more failing blocks of the flash-based storage device. For example, the system may read one or more erasure counters from the drive or an operating system and compare the count for each location to a limit established by the manufacturer of the device. The system identifies those locations with counts near the limit as failing or expiring blocks, and may seek to relocate data associated with these blocks.

Continuing in decision block 420, if the system found any failing blocks, then the system continues in block 430, else the system completes. The system may periodically check for failing blocks, such as in the process of an operating system's idle processing or as a routine scheduled maintenance task.

Continuing in block 430, the system selects one or more data items stored on the flash-based storage device that can be removed to make room for data stored in the detected failing blocks. The data to be removed may include data that has not been accessed in a long time, data that is easily recoverable (e.g., is stored elsewhere or is unimportant), and so on. Continuing in block 440, the system optionally prompts the user to determine whether the user approves of the system deleting the selected data items. In some embodiments, the system may suggest moving the data items and allow the user to burn the items to an optical disk, copy them to a USB drive or cloud-based storage service, and so on.

Continuing in decision block 450, if the system receives approval from the user to delete the selected data items, then the system continues at block 460, else the system completes. If the user does not approve of deleting the items, then the system may still be able to take other actions automatically (not shown), such as moving data around to make more less worn blocks available. Continuing in block 460, the system deletes the selected data items and flags the data in failing blocks for migration to one or more locations vacated by the deleted data items. The system may immediately move the data in failing blocks or may wait until the data is next written. For some types of devices, there is little risk that data already successfully written to a location will be lost, and the risk is incurred when another attempt to write to the location is made. In such cases, the system may optimistically assume that the data will not be written again (and thus not migrate the data), but if the data is in fact written the system can move the data at that time.

In some embodiments, the storage placement system selects placement of data for non-flash-based storage devices. Although the system is helpful for increasing the lifetime and efficiency of flash-based devices, the system can also be used to improve data storage on other media. For example, optical media can often benefit from proper data placement, and management of hot and cold data. Many types of optical media are rewriteable a fixed number of times, and proper selection and placement of data can allow an optical medium to be used for a longer period. For example, an optical disk drive may be selected to store infrequently changing data, and data that needs to be rewritten can be circulated over the drive over time to wear sectors evenly.

In some embodiments, the storage placement system is implemented in firmware of a flash-based storage device. Although the techniques described herein involve levels of understanding of data use, particularly involving file systems, a device's firmware can be programmed with an understanding of common file systems so that for those file systems, the firmware can manage storage on the drive more effectively. Placing the system in firmware allows improvements in data storage on systems for which operating system updates and modifications are less desirable. In some environments, such as some smartphones, the firmware is implemented in a driver as part of the operating system, so changes can be made to a driver to implement the system without broader operating system modifications.

From the foregoing, it will be appreciated that specific embodiments of the storage placement system have been described herein for purposes of illustration, but that various modifications may be made without deviating from the spirit and scope of the invention. Accordingly, the invention is not limited except as by the appended claims.

I/We claim:

1. A computer-implemented method for writing data to a selected location on a flash-based storage device, the method comprising:
receiving a request to write data to a flash-based storage device;
qualifying a frequency of access associated with the data to be written to the flash-based storage device;
selecting a data placement location on the flash based storage device for the data to be written based on the qualified frequency of access of the data;
sending placement information to the flash-based storage device, indicating the selected data placement location for the data to be written; and
storing the requested data at the selected data placement location on the flash-based storage device,
wherein the preceding steps are performed by at least one processor.

2. The method of claim 1 wherein receiving the request comprises a request received by an operating system in which the method is implemented as a file system driver, by firmware, or directly in hardware to manage placement of data on flash-based devices.

3. The method of claim 1 wherein receiving the request comprises receiving additional information about the data to be written that describes a purpose for the data.

4. The method of claim 1 wherein receiving the request comprises receiving additional information about the data to be written that describes a frequency of access needed for the data.

5. The method of claim 1 wherein qualifying the data comprises determining how frequently the data will be read and how frequently the data will be written.

6. The method of claim 1 wherein qualifying the data comprises qualifying the data based on historical access patterns for a file system location associated with the data.

7. The method of claim 1 wherein qualifying the data comprises qualifying the data based on meta-information received with the request.

8. The method of claim 1 wherein qualifying the data comprises qualifying the data based on well-known operating system implementation information.

9. The method of claim 1 wherein selecting the placement location comprises informing the device of the qualified frequency of access of the data and allowing the device to select a location for the data.

10. The method of claim 1 wherein selecting the placement location comprises identifying a worn block as a suitable location for data that will not be written again frequently.

11. The method of claim 1 wherein selecting the placement location comprises selecting a location on a separate, secondary storage device for holding data that is less suitable for the flash-based storage device.

12. The method of claim 1 wherein sending placement information comprises providing the information to the device as a parameter to a command for writing data to the drive.

13. A computer system for managing data placement on flash-based storage by use, the system comprising:
a processor and memory configured to execute software instructions embodied within the following components;
a flash-based storage device that includes at least some flash-based memory for non-volatile data storage;
a data qualification component that qualifies data received by an operating system by a frequency with which the data is likely to be written, wherein data that is written often is called hot data and data that is written infrequently is called cold data;
a data monitoring component that monitors data read and written by an operating system and stores historical use information for data;
a data placement component that determines one or more locations to which data to be written to the flash-based storage device will be written among all of the locations available from the device; and
a storage communication component that provides an interface between the other components of the system and the flash-based storage device.

14. The system of claim 13 wherein the data qualification component accesses historical data access information acquired by the data monitoring component, as well as using specific-knowledge implicitly or explicitly supplied by the operating system describing particular data's purpose.

15. The system of claim 13 wherein the data monitoring component monitors which files are used under various conditions and at various times, which files are accessed together, and how recoverable a particular data chunk is.

16. The system of claim 13 wherein the data placement component uses the qualification of data determined by the data qualification component to determine where data should be located, and uses the storage communication component to access drive information tracked by the drive firmware or hardware.

17. The system of claim 13 wherein the data placement component selects a location that is good for both the longevity of the drive and a level of performance appropriate for the data to be written.

18. The system of claim 13 wherein the data placement component selects locations with increasingly longer latencies as the data's access frequency decreases.

19. The system of claim 13 further comprising a failure management component that handles access and/or movement of data to and from the flash-based storage device as the device is approaching its wear limit based on a difficulty of recovering data if lost.

20. A computer-readable storage medium comprising instructions for controlling a computer system to select a placement location for data to be written on a flash-based storage device, wherein the instructions, upon execution, cause a processor to perform actions comprising:
receiving information that qualifies an access frequency of data to be written to the flash-based storage device;
upon determining that the data will be infrequently written,
identifying one or more worn locations of the flash-based storage device at which the infrequently written data can reside to retain less worn locations available for other data; and
selecting one of the identified more worn locations to which to write the data; and
upon determining that the data will be frequently written,
locating any other frequently written data related to the data to be written; and
selecting a less worn location near the other frequently written data at which to place the data to be written; and
reporting the selected placement to a component for writing the data to the selected location.
